(19) United States
(12) Patent Application Publication
(10) Pub. No.: US 2023/0266944 A1
(43) Pub. Date: Aug. 24, 2023

(54) MULTIMODE PHYSICAL UNCLONABLE FUNCTION AS AN ENTROPY SOURCE FOR GENERATING TRUE RANDOM BIT

(71) Applicant: SK hynix, Gyeonggi-do (KR)

(72) Inventors: Alexander IVANIUK, Minsk (BY); Siarhei ZALIVAKA, Minsk (BY)

(21) Appl. No.: 17/675,926

(22) Filed: Feb. 18, 2022

(51) Int. Cl. G06F 7/58

(52) U.S. Cl. CPC G06F 7/588; H04L 9/0866

(57) ABSTRACT

A circuit and associated method for providing a true random and unclonable output from the circuit. In the circuit and method, an enable signal is received at a first port of a latch, and a data input signal is received at a second port of the latch. Via an inverter coupled to the latch circuit, an inversion signal of output data from the latch is generated. The inversion of the signal is fed to the second port, and the latch circuit and the inverter are operated to provide the true random and unclonable output.

### BACKGROUND

### 1. Field

Embodiments of the present disclosure relate to random number generation algorithms.

### 2. Description of the Related Art

The computer environment paradigm has shifted to ubiquitous computing systems that can be used anytime and anywhere. As a result, the use of portable electronic devices such as mobile phones, digital cameras, and notebook computers has rapidly increased. These portable electronic devices generally use a memory system having memory device(s), that is, data storage device(s). The data storage device is used as a main memory device or an auxiliary memory device of the portable electronic devices.

Data storage devices using memory devices provide excellent stability, durability, high information access speed, and low power consumption, since they have no moving parts. Examples of data storage devices having such advantages include universal serial bus (USB) memory devices, memory cards having various interfaces, and solid state drives (SSD).

The SSD may include flash memory components and a controller, which includes the electronics that bridge the flash memory components to the SSD input/output (I/O) interfaces. The SSD controller may include an embedded processor that executes functional components such as firmware. The SSD functional components are typically device specific, and in most cases, can be updated.

The two main types of flash memories are named after the NAND and NOR logic gates. The individual flash memory cells exhibit internal characteristics similar to those of their corresponding gates. The NAND-type flash memory may be written to and read from in blocks (or pages) which are generally much smaller than the entire memory space. The NAND-type flash memory operates primarily in memory cards, USB flash drives, solid-state drives (SSDs), and similar products, for general storage and transfer of data.

Modern NAND-type flash storage devices use different types of physical blocks, which are distinguished by the types of memory cell therein. A physical block may comprise (i) single-level cells (SLCs), each capable of storing a single bit, (ii) multi-level cells (MLCs), each capable of storing two bits, (iii) triple-level cells (TLCs), each capable of storing three bits, or (iv) quad-level cells (QLCs), each capable of storing four bits. The memory cells in a given block are grouped to define pages. To increase overall storage capacity, the trend has been to implement NAND-type flash storage devices with higher capacity memory cells, i.e., SLC to MLC to TLC to QLC. Doing so, however, has led to reliability issues.

A physical unclonable function (PUF) can be used for a variety of purposes including security. In general, because of manufacturing variations, semiconductor chips have been used to implement a physical unclonable function (PUF). Even with precise manufacturing step, a random noise generated from a fabricated semiconductor chip is almost impossible to copy, and thereby provides for a reliable physical unclonable function which produces an unclonable output.

As described in U.S. Pat. Appl. Publ. No. 2021/0055912 (the entire contents of which are incorporated herein by reference), physically unclonable functions (PUFs) are widely used as hardware primitives for unique integrated circuit identification and true random number generation (TRNG).

As described in U.S. Pat. No. 9,201,630 (the entire contents of which are incorporated herein by reference), nonvolatile mass-storage memory drives present a variety of security problems when used to store sensitive data. To combat these security problems, some drives automatically encrypt data as it is stored.

As detailed in the ‘630 patent, generated random numbers, can be used as part of the cryptographic algorithms. For instance, some cryptographic algorithms rely upon data being unpredictable. To achieve this unpredictability, some cryptographic algorithms may require a steady supply of random numbers. The strength of such cryptographic algorithms is often only as good as the random number generation process.

More specifically, random numbers can be used to generate encryption keys that are then used to provide encrypted secure communication. Many cryptographic algorithms use nonces (numbers only used once). Hard disc drives have a number of physical entropy sources that can be used to initialize or seed cryptographic random number generators. Many of these physical entropy sources are derived from the mechanical movement of the disk drive components. The entropy of such physical sources provides a level of confidence that the generated random numbers are truly random.

Indeed, true random number generators (TRNG) have been used in a wide range of applications (e.g., cryptography, statistical sampling, simulation, computer games, etc.). The main advantage of TRNGs comparing to pseudorandom number generators (PRNGs) is the uniqueness and unpredictability of their produced output values.

A TRNG is a device or a part of a device that generates random numbers based on some intrinsic physical process. One of the possible ways of extracting random data from electronic devices involves physical unclonable functions (PUF). PUFs have been usually utilized for both stable secret keys and random numbers generation.

### SUMMARY

In one aspect of the present invention, there is provided a latching circuit. The latching circuit has a latch including a first input port, a second input port, and an output port. The latch is configured to receive an enable signal at the first input port. The latching circuit has an inverter coupled to the latch, configured to generate an inverted signal of data output from the latch, and configured to provide the inverted signal back to the second input port. The latch and the inverter operate as a memory when the enable signal has a first level, operate as a ring oscillator when the enable signal has a second level, and may have a metastable state when the enable signal changes from the second level to the first level.

In another aspect of the present invention, there is a method for providing an unclonable output from a circuit. This method receives an enable signal at a first port of a latch, receives a data input signal at a second port of the latch, generates via an inverter coupled to the latch circuit an inversion of the signal of output data from the latch, feeds the inversion of the signal to the second port, and operates the latch circuit and the inverter to provide the unclonable output.

Additional aspects of the present invention will become apparent from the following description.

### BRIEF DESCRIPTION OF THE DRAWINGS

FIG. 1 is a block diagram illustrating a memory system in accordance with one embodiment of the present invention.

FIG. 2 is a block diagram illustrating a memory system in accordance with another embodiment of the present invention.

FIG. 3 is a circuit diagram illustrating a memory block of a memory device in accordance with still another embodiment of the present invention.

FIG. 4 is a depiction of the PUF circuit according to one embodiment of the present invention.

FIG. 5 is a depiction of Ring Oscillator and Latch D-type (ROLD) circuit according to one embodiment of the present invention.

FIG. 6 is a depiction of an equivalent circuit for the ROLD circuit of FIG. 5.

FIG. 7 is a depiction of an equivalent bi-stable element circuit for the ROLD circuit of FIG. 5.

FIG. 8 is a depiction of another equivalent circuit for the ROLD circuit of FIG. 5.

FIG. 9 is a depiction of an equivalent ROLD circuit.

FIG. 10A is a depiction showing an SR-latch timing diagram depending on a changing EN signal.

FIG. 10B is a depiction of one scenario for generating metastable values.

FIG. 10C is a depiction of another scenario for generating metastable values.

FIG. 11 is a depiction of a multi-bit latch for storing a unique ID or a random value generated by a PUF circuit.

FIG. 12 is a graph showing probabilities of ‘0’ and ‘1’ values in an initialization mode of a PUF circuit.

FIG. 13 is a graph depicting the observed frequencies in a ring oscillator RO mode of a PUF circuit.

FIG. 14 is a graph showing probabilities of ‘0’ and ‘1’ values in a metastability mode of a PUF circuit.

FIG. 15 is a graph showing a distribution of 128-bit random values generated by a PUF circuit.

FIG. 16 is a diagram illustrating a method for providing an unclonable output from a circuit in accordance with another embodiment of the present invention.

### DETAILED DESCRIPTION

Various embodiments of the present invention are described below in more detail with reference to the accompanying drawings. The present invention may, however, be embodied in different forms and thus should not be construed as limited to the embodiments set forth herein. Rather, these embodiments are provided so that this disclosure conveys the scope of the present invention to those skilled in the art. Moreover, reference herein to “an embodiment,” “another embodiment,” or the like is not necessarily to only one embodiment, and different references to any such phrase are not necessarily to the same embodiment(s). The term “embodiments” as used herein does not necessarily refer to all embodiments. Throughout the disclosure, like reference numerals refer to like parts in the figures and embodiments of the present invention.

The present invention can be implemented in numerous ways, including as a process; an apparatus; a system; with some component including a computer program product embodied on a computer-readable storage medium; and/or a processor, such as a processor suitable for executing instructions stored on and/or provided by a memory coupled to the processor. In this specification, these implementations, or any other form that the present invention may take, may be referred to as techniques. In general, the order of the operations of disclosed processes may be altered within the scope of the present invention. Unless stated otherwise, a component such as a processor or a memory described as being suitable for performing a task may be implemented as a general device or circuit component that is configured or otherwise programmed to perform the task at a given time or as a specific device or circuit component that is manufactured to perform the task. As used herein, the term ‘processor’ or the like refers to one or more devices, circuits, and/or processing cores suitable for processing data, such as computer program instructions.

The methods, processes, and/or operations described herein may be performed by code or instructions to be executed by a computer, processor, controller, or other signal processing device. The computer, processor, controller, or other signal processing device may be those described herein or in addition to the elements described herein. Because the algorithms that form the basis of the methods (or operations of the computer, processor, controller, or other signal processing device) are described herein, the code or instructions for implementing the operations of the method embodiments may transform the computer, processor, controller, or other signal processing device into a special-purpose processor for performing the methods herein.

If implemented at least partially in software, the controllers, processors, devices, modules, units, multiplexers, generators, logic, interfaces, decoders, drivers, generators and other signal generating and signal processing features may include, for example, a memory or other storage device for storing code or instructions to be executed, for example, by a computer, processor, microprocessor, controller, or other signal processing device.

A detailed description of embodiments of the present invention is provided below along with accompanying figures that illustrate aspects of the present invention. The present invention is described in connection with such embodiments, but the present invention is not limited to any specific embodiment. The present invention encompasses numerous alternatives, modifications and equivalents. Numerous specific details are set forth in the following description in order to provide a thorough understanding of the present invention. These details are provided for the purpose of example; the present invention may be practiced according to the claims without some or all of these specific details. For clarity, technical material that is known in technical fields related to the present invention has not been described in detail so that the present invention is not unnecessarily obscured.

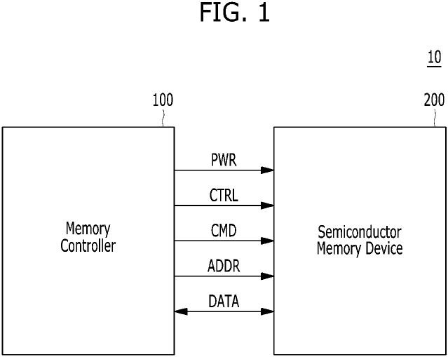

FIG. 1 is a block diagram schematically illustrating a memory system in accordance with an embodiment of the present invention.

Referring FIG. 1, the memory system 10 may include a memory controller 100 and a semiconductor memory device 200, which may represent more than one such device. In general, the present invention can be implemented as a part of any digital hardware system. In various embodiments, the semiconductor memory device(s) 200 are preferably flash memory device(s), particularly of the MLC, TLC and/or QLC NAND-type. For brevity, semiconductor memory device 200 is sometimes simply referred to as memory device 200, NAND-type flash memory 200.

The memory controller 100 may control overall operations of the semiconductor memory device 200.

The semiconductor memory device 200 may perform one or more erase, program, and read operations under the control of the memory controller 100. The semiconductor memory device 200 may receive a command CMD, an address ADDR and data DATA through input/output (I/O) lines. The semiconductor memory device 200 may receive power PWR through a power line and a control signal CTRL through a control line. The control signal CTRL may include a command latch enable signal, an address latch enable signal, a chip enable signal, a write enable signal, a read enable signal, and the like.

The memory controller 100 and the semiconductor memory device 200 may be integrated in a single semiconductor device such as a solid state drive (SSD). The SSD may include a storage device for storing data therein. When the semiconductor memory system 10 is used in an SSD, operation speed of a host (not shown) coupled to the memory system 10 may remarkably improve.

The memory controller 100 and the semiconductor memory device 200 may be integrated in a single semiconductor device such as a memory card. For example, the memory controller 100 and the semiconductor memory device 200 may be so integrated to configure a PC card of personal computer memory card international association (PCMCIA), a compact flash (CF) card, a smart media (SM) card, a memory stick, a multimedia card (MMC), a reduced-size multimedia card (RS-MMC), a micro-size version of MMC (MMCmicro), a secure digital (SD) card, a mini secure digital (miniSD) card, a micro secure digital (microSD) card, a secure digital high capacity (SDHC), and/or a universal flash storage (UFS).

In another embodiment, the memory system 10 may be provided as one of various components in an electronic device such as a computer, an ultra-mobile PC (UMPC), a workstation, a net-book computer, a personal digital assistant (PDA), a portable computer, a web tablet PC, a wireless phone, a mobile phone, a smart phone, an e-book reader, a portable multimedia player (PMP), a portable game device, a navigation device, a black box, a digital camera, a digital multimedia broadcasting (DMB) player, a 3-dimensional television, a smart television, a digital audio recorder, a digital audio player, a digital picture recorder, a digital picture player, a digital video recorder, a digital video player, a storage device of a data center, a device capable of receiving and transmitting information in a wireless environment, a radio-frequency identification (RFID) device, as well as one of various electronic devices of a home network, one of various electronic devices of a computer network, one of electronic devices of a telematics network, or one of various components of a computing system.

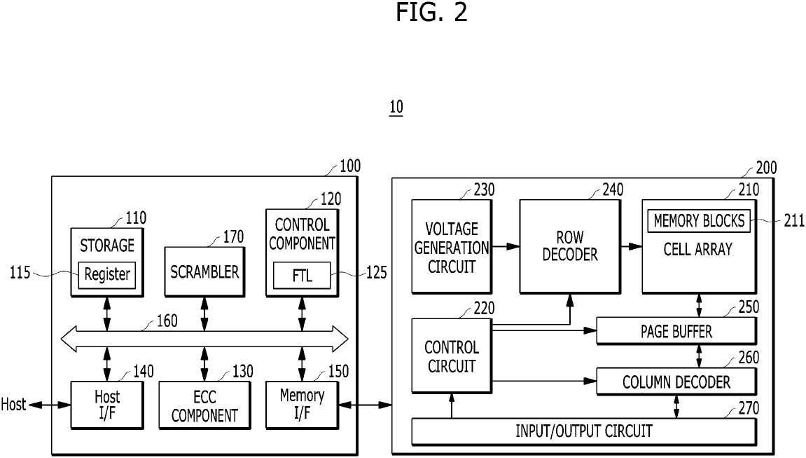

FIG. 2 is a detailed block diagram illustrating a memory system in accordance with an embodiment of the present invention. For example, the memory system of FIG. 2 may depict the memory system 10 shown in FIG. 1.

Referring to FIG. 2, the memory system 10 may include a memory controller 100 and a semiconductor memory device 200. The memory system 10 may operate in response to a request from a host device, and in particular, store data to be accessed by the host device.

The host device may be implemented with any one of various kinds of electronic devices. In some embodiments, the host device may include an electronic device such as a desktop computer, a workstation, a three-dimensional (3D) television, a smart television, a digital audio recorder, a digital audio player, a digital picture recorder, a digital picture player, and/or a digital video recorder and a digital video player. In some embodiments, the host device may include a portable electronic device such as a mobile phone, a smart phone, an e-book, an MP3 player, a portable multimedia player (PMP), and/or a portable game player.

The memory device 200 may store data to be accessed by the host device.

The memory device 200 may be implemented with a volatile memory device such as a dynamic random access memory (DRAM) and/or a static random access memory (SRAM) or a non-volatile memory device such as a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM), and/or a resistive RAM (RRAM).

The controller 100 may control storage of data in the memory device 200. For example, the controller 100 may control the memory device 200 in response to a request from the host device. The controller 100 may provide data read from the memory device 200 to the host device, and may store data provided from the host device into the memory device 200.

The controller 100 may include a storage 110, a control component 120, which may be implemented as a processor such as a central processing unit (CPU), an error correction code (ECC) component 130, a scrambler 170, a host interface (I/F) 140 and a memory interface (I/F) 150, which are coupled through a bus 160.

The storage 110 may serve as a working memory of the memory system 10 and the controller 100, and store data for driving the memory system 10 and the controller 100. When the controller 100 controls operations of the memory device 200, the storage 110 may store data used by the controller 100 and the memory device 200 for such operations as read, write, program and erase operations.

The storage 110 may be implemented with a volatile memory such as a static random access memory (SRAM) or a dynamic random access memory (DRAM). As described above, the storage 110 may store data used by the host device in the memory device 200 for the read and write operations. To store the data, the storage 110 may include a program memory, a data memory, a write buffer, a read buffer, a map buffer, and the like. The storage 110 may also include a register 115, which may be used as described below.

The control component 120 may control general operations of the memory system 10, and a write operation or a read operation for the memory device 200, in response to a write request or a read request from the host device. The control component 120 may drive firmware, which is referred to as a flash translation layer (FTL) 125, to control general operations of the memory system 10. For example, the FTL 125 may perform operations such as logical-to-physical (L2P) mapping, wear leveling, garbage collection (GC), and/or bad block handling. The FTL 125 may be implemented, as a firmware, in the control component 120 or in the controller 100. The L2P mapping is known as logical block addressing (LBA).

The ECC component 130 may detect and correct errors in the data read from the memory device 200 during the read operation. The ECC component 130 may not correct error bits when the number of the error bits is greater than or equal to a threshold number of correctable error bits, and instead may output an error correction fail signal indicating failure in correcting the error bits.

The ECC component 130 may perform an error correction operation based on a coded modulation, such as a low-density parity-check (LDPC) code, a Bose-Chaudhuri-Hocquenghem (BCH) code, a turbo code, a turbo product code (TPC), a Reed-Solomon (RS) code, a convolution code, a recursive systematic code (RSC), a trellis-coded modulation (TCM), or a block coded modulation (BCM). The ECC component 130 may include any and all circuits, systems or devices for suitable error correction operation.

The scrambler 170 may be used to uniformly distribute bits in data send from a host before storing such data in the memory device 200. This helps to increase reliability of the memory device 200 and decrease wear-out effects. The scrambler 170 may be implemented based on a linear feedback shift register (LFSR). Alternatively, the scrambler 170 may be implemented in any other suitable way.

The host interface 140 may communicate with the host device through one or more of various interface protocols such as a universal serial bus (USB), a multi-media card (MMC), a peripheral component interconnect express (PCI-e or PCIe), a small computer system interface (SCSI), a serial-attached SCSI (SAS), a serial advanced technology attachment (SATA), a parallel advanced technology attachment (PATA), an enhanced small disk interface (ESDI), and an integrated drive electronics (IDE).

The memory interface 150 may provide an interface between the controller 100 and the memory device 200 to allow the controller 100 to control the memory device 200 in response to a request from the host device. The memory interface 150 may generate control signals for the memory device 200 and process data under the control of the control component or CPU 120. When the memory device 200 is a flash memory such as a NAND flash memory, the memory interface 150 may generate control signals for the memory and process data under the control of the CPU 120.

The memory device 200 may include a memory cell array 210, a control circuit 220, a voltage generation circuit 230, a row decoder 240, a page buffer (array) 250, which may be in the form of an array of page buffers, a column decoder 260, and an input/output circuit 270. The memory cell array 210 may include a plurality of memory blocks 211 which may store data. Subsets of the memory blocks may be grouped into respective super blocks (SBs) for certain operations.

The voltage generation circuit 230, the row decoder 240, the page buffer 250, the column decoder 260 and the input/output circuit 270 may form a peripheral circuit for the memory cell array 210. The peripheral circuit may perform a program, read, or erase operation of the memory cell array 210. The control circuit 220 may control the peripheral circuit.

The voltage generation circuit 230 may generate operation voltages of various levels. For example, in an erase operation, the voltage generation circuit 230 may generate operation voltages of various levels such as an erase voltage and a pass voltage.

The row decoder 240 may be in electrical communication with the voltage generation circuit 230, and the plurality of memory blocks 211. The row decoder 240 may select at least one memory block among the plurality of memory blocks 211 in response to a row address RADD generated by the control circuit 220, and transmit operation voltages supplied from the voltage generation circuit 230 to the selected memory blocks.

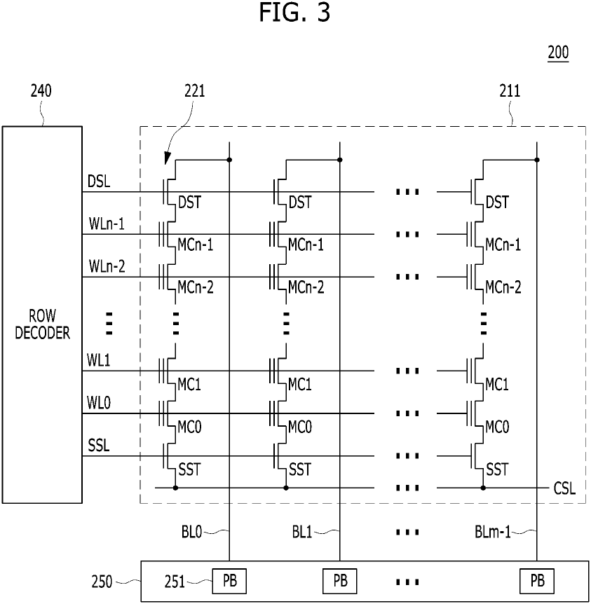

The page buffer 250 may be in electrical communication with the memory cell array 210 through bit lines BL (shown in FIG. 3). The page buffer 250 may pre-charge the bit lines BL with a positive voltage, transmit data to, and receive data from, a selected memory block in program and read operations, or temporarily store transmitted data, in response to page buffer control signal(s) generated by the control circuit 220.

The column decoder 260 may transmit data to, and receive data from, the page buffer 250, and may also exchange data with the input/output circuit 270.

The input/output circuit 270 may transmit to the control circuit 220 a command and an address, received from an external device (e.g., the memory controller 100), transmit data from the external device to the column decoder 260, or output data from the column decoder 260 to the external device, through the input/output circuit 270.

The control circuit 220 may control the peripheral circuit in response to the command and the address.

FIG. 3 is a circuit diagram illustrating a memory block of a semiconductor memory device in accordance with an embodiment of the present invention. For example, the memory block of FIG. 3 may be any of the memory blocks 211 of the memory cell array 200 shown in FIG. 2.

Referring to FIG. 3, the exemplary memory block 211 may include a plurality of word lines WL0 to WLn-1, a drain select line DSL and a source select line SSL coupled to the row decoder 240. These lines may be arranged in parallel with the plurality of word lines between the DSL and SSL.

The exemplary memory block 211 may further include a plurality of cell strings 221 respectively coupled to bit lines BL0 to BLm-1. The cell string of each column may include one or more drain selection transistors DST and one or more source selection transistors SST. In the illustrated embodiment, each cell string has one DST and one SST. In a cell string, a plurality of memory cells or memory cell transistors MC0 to MCn-1 may be serially coupled between the selection transistors DST and SST. Each of the memory cells may be formed as a single-level cell (SLC), a multi-level cell (MLC), triple-level cell (TLC), quad-level cell (QLC) or higher-level cell storing data information.

The source of the SST in each cell string may be coupled to a common source line CSL, and the drain of each DST may be coupled to the corresponding bit line. Gates of the SSTs in the cell strings may be coupled to the SSL, and gates of the DSTs in the cell strings may be coupled to the DSL. Gates of the memory cells across the cell strings may be coupled to respective word lines. That is, the gates of memory cells MC0 are coupled to corresponding word line WL0, the gates of memory cells MC1 are coupled to corresponding word line WL1, etc. The group of memory cells coupled to a particular word line may be referred to as a physical page. Therefore, the number of physical pages in the memory block 211 may correspond to the number of word lines.

As previously noted, the page buffer 250 may be in the form of a page buffer array including a plurality of page buffers 251 that are coupled to the bit lines BL0 to BLm-1. The page buffers 251 may operate in response to page buffer control signals. For example, the page buffers 251 my temporarily store data received through the bit lines BL0 to BLm-1 or sense voltages or currents of the bit lines during a read or verify operation.

While as noted above that the present invention can be implemented as a part of any digital hardware system, the memory blocks 211 may include a particular capacity NAND-type or NOR-type flash memory cells. Memory cell array 210 also may be implemented as a hybrid flash memory in which two or more types of memory cells are combined, or as a one-NAND flash memory in which a controller is embedded inside a memory chip. Memory blocks 211 comprising higher-capacity NAND-type flash memory cells, e.g., NAND MLCs, TLCs, QLCs, have particular applicability to the present invention.

As previously noted, increasing the capacity of the memory cells used to implement the NAND-type flash memory 200 has led to reliability issues. As described in the ‘912 publication noted above, this downside can be used for an opposite purpose, i.e., faults in blocks and pages can be utilized as a source of uniqueness for both chip identification and true random number generation (TRNG). Modern MLC, TLC and QLC NAND flash memory devices 200 tend to have massive ECC engines which negotiate the effect of intrinsic NAND instability.

### Hardware Design

In one embodiment of the present invention, a physical unclonable function circuit (referred to herein as a “PUF circuit”) is based on using an inverter and a D-Latch which are controlled by an enable (EN) signal. In one aspect of the invention, the PUF circuit requires hardware to generate the noise and is not be implemented purely in software. While software may used to control the circuit, it does not generate the random numbers. The PUF circuit can operate in four modes, namely, in an initial memory mode, a ring oscillator mode, a metastability mode, and a latch mode. These modes are described in more detail below. All these modes can be used for different purposes, e.g., generating a unique identifier in the initial memory mode, generating random numbers in the ring oscillator or metastability modes, and storing generated ID or random value in the latch mode.

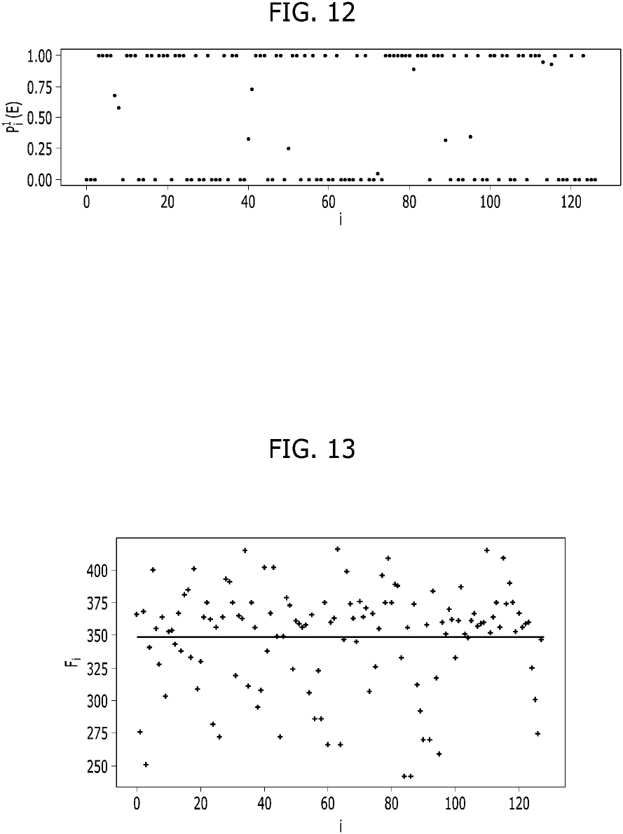

Thus, the inventive PUF circuit supports different PUF routines in a single device. One of the main challenges in TRNG design are consumed area and performance (rate for random bit generation). The inventive PUF circuit provides for a TRNG design which is compact in that it consumes only an area of four logic gates and which is fast as ring oscillators and therefore may operate at a high frequency such as for example but not limited to the operational frequencies from 250 to 400 MHz shown in FIG. 13.

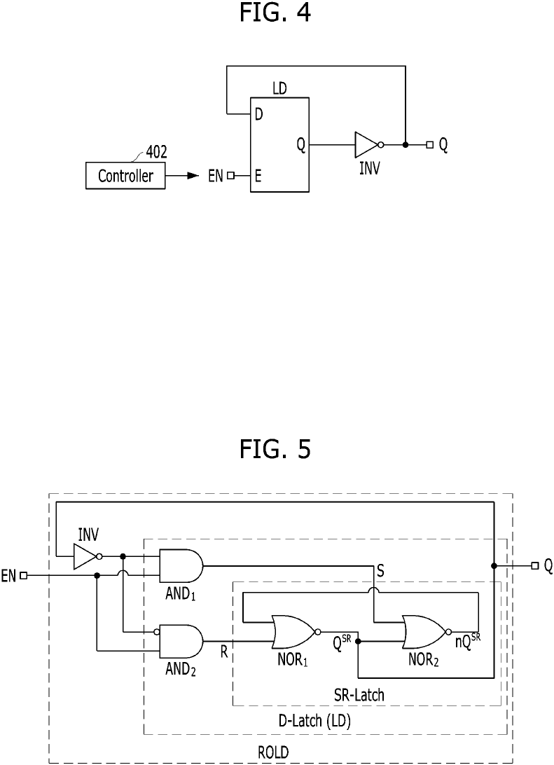

FIG. 4 is a depiction of the PUF circuit according to one embodiment of the present invention. Here, in one embodiment of the present invention, there is provided a PUF circuit functioning as an entropy source (i.e., a physical source of noise in true random number generator) for random bit generation, the circuit having the two elements noted above, namely, Latch D-type (LD) and Inverter INV. D-type lath circuits are known in the art as exemplified by U.S. Pat. Nos. 5,410,550; 5,903,175; 6,414,529; and 7,872,514 (the entire contents of each patent are incorporated herein by reference). In general, a D-type latch is an electronic device that can store one bit of information, that is it can capture or ‘latch’ the logic level present on data line input D for example when an enable signal is high. The D-type latch is an asynchronous device. If the data on the D line changes state while the enable pulse is high, then the output Q, follows the input D. When the enable input is low, the last state of the D input is trapped and held in the D-type latch.

As shown in FIG. 4, in the inventive PUF circuit, there is an inverter INV connected to an output Q of the latch LD. The inverter forms a negative feedback loop providing a signal back to input D of the latch LD. An enable signal EN is provided to input E of the latch LD. The operation of the PUF circuit is controlled by the enable signal EN. The enable signal may be provided by control component 120 and/or control circuit 220 (shown in FIG. 2), or by a dedicated controller 402 as shown in FIG. 4.

As noted above, the inventive PUF circuit supports four modes of operation:
Initial memory. This mode works is for use during start-up and EN=‘0’. In this mode, the PUF circuit works much like a static random access memory (SRAM) in that it can retain data bits as long as power is being supplied. In this mode, latch LD can generate either stable ‘0’ or stable ‘1’ or a metastable value. Others (evaluating the behavior of SRAMs) have shown that the output Q has a 10% chance of generating metastable value. When the output Q can be made stable (as in the inventive PUF circuit), the output Q can be used as a bit of a unique device ID.
Ring oscillator (RO). If enable signal is kept over time as EN=‘1’, the PUF circuit produces a meander signal with a unique frequency F_{Q} which can be utilized for random bit generation and operating similar to a ring oscillator RO PUF. For example, a clock signal having a meander shape would have the levels of the signal changing (e.g., periodically) from high to low or from low to high with the frequency remaining substantially the same.
Metastability. Since the latch LD is asynchronous and since the value on data input (D) of the latch is unpredictable, changing EN signal value from ‘1’ to ‘0’ can violate timing parameters of the latch LD. In this case, latch LD may fall into a metastable state, and the output Q over time can be either ‘0’ or ‘1’.
Latch. If the enable signal is kept over time as EN=‘0’, then latch LD can store a random bit received at input D, and the output Q value is stable.

As a result, the inventive PUF circuit can be used to generate a unique stable ID bit (mode 1) or random values (mode 2 and 3) or store a generated ID or a random bit (mode 4).

FIG. 5 is a depiction of Ring Oscillator and Latch D-type (ROLD) circuit according to one embodiment of the present invention. More specifically, FIG. 5 depicts a gate level of an entropy source circuit utilizing the PUF circuit of FIG. 4. The circuit shown in FIG. 5 is a combination of different circuits, i.e. Ring Oscillator and Latch D-type.

The D-Latch component depicted in FIG. 5 includes a basic SR-Latch circuit which has S (set) and R (reset) inputs and has two complementary data outputs Q^{SR} and nQ^{SR}. For the case where SR-Latch is configured with the NOR2 gates (e.g., NOR1 and NOR2 shown FIG. 5), there are the following operational modes:
Setting ‘1’ (when S=‘1’ and R=‘0’),
Resetting ‘0’ (when S=‘0’ and R=‘1’),
Storing value mode (when S=‘0’ and R=‘0’) and
Forbidden mode (when S=‘1’ and R=‘1’).

A transaction from the Forbidden mode to Storing value mode may generate metastable value(s) on outputs Q^{SR} and nQ^{SR}. The D-type Latch (as shown in FIG. 5) is configured with the SR-Latch such to prevent the occurrence of a Forbidden mode by keeping S and R inputs in opposite values. The Storing mode is provided for by additional input EN of an enable signal and two additional AND2 gates (e.g., AND1 and AND2 in FIG. 5).

Described below are the “equivalent circuits” operating during the four modes discussed above:

### Initial Memory

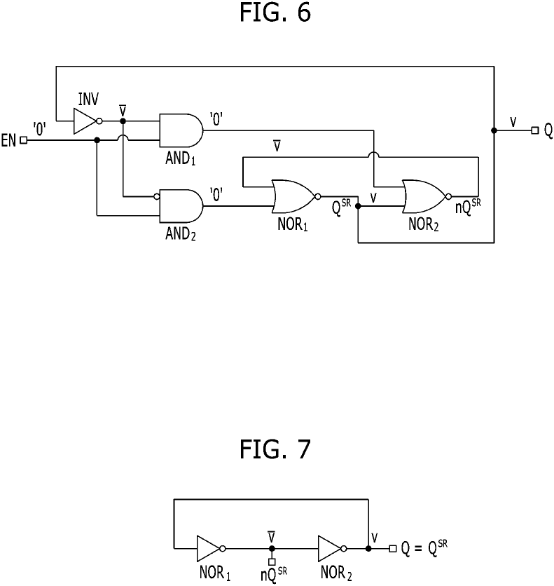

When EN=‘0’, the circuit of FIG. 5 is equivalent to SR-latch in storing mode (S=‘0’, R=‘0’). FIG. 6 is a depiction of an equivalent circuit for the ROLD circuit of FIG. 5 for EN=‘0’.

In this mode, AND elements (AND1 and AND2) generate constant ‘0’ values and can be omitted for analysis of this circuit. NOR elements (NOR1 and NOR2) operate as inverters. Therefore, a circuit in this mode operates as a bi-stable element as shown in FIG. 7.

During the initialization (power-up) stage, the default value v (the output of the PUF circuit) is unknown due to manufacturing process variations (possible asymmetry of NOR gates NOR1 and NOR2 and connection wires between them). Therefore, unique ID values can be obtained from this PUF circuit during power-up, similar to that seen when powering up SRAM cells which also can be considered as bi-stable elements.

### Ring Oscillator (RO)

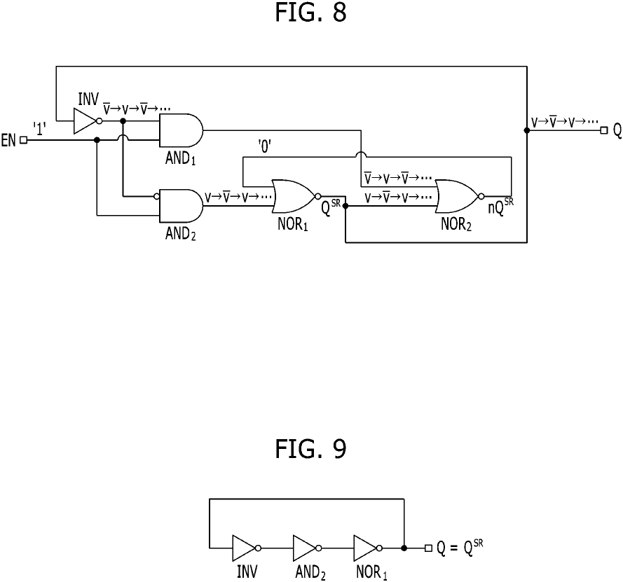

When EN=‘1’, SR-Latch switches between Setting (S=‘1’, R=‘0’) and Resetting (S=‘0’, R=‘1’) modes based on the value obtained from inverter INV output as shown in FIG. 8. FIG. 8 is a depiction of an equivalent circuit for the ROLD circuit of FIG. 5 for EN=‘1’.

In this mode, AND1 element operates as a buffer repeating v or ν̅ values, NOR2 element works as a constant ‘0’ value generator, AND2 and NOR1 are identical to two inverters. This mode of operation is equivalent to the Ring Oscillator circuit with three inverters as shown in FIG. 9.

Thus, a meander signal (v → ν̅ → v → ...) with unique frequency F_{Q} appears on the output Q of the PUF circuit. F_{Q} is determined by manufacturing process variations which make the negative feedback loop delay unpredictable.

### Metastability

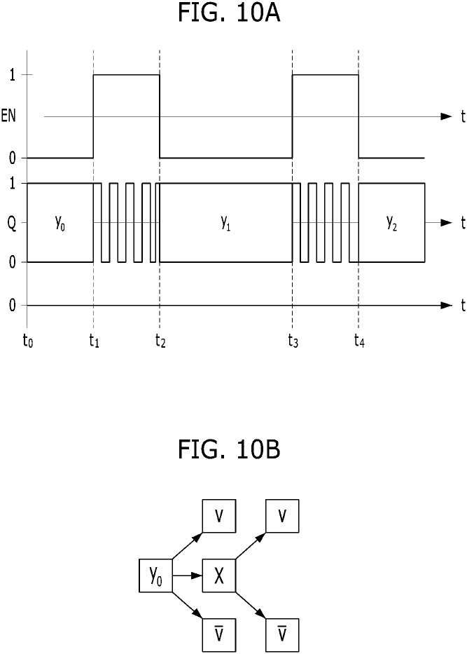

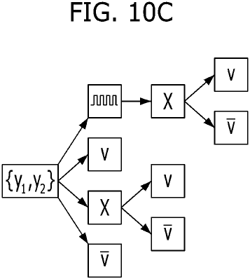

Timing diagram in FIG. 10A shows three output values y0, y1, y2 from the output Q. There are two possible ways that a metastable state can appear on the output Q. First, initial value y0 ∈{v, X, ν̅} (period of time from t0 to t1 as shown in FIG. 10A) can be either stable v^{∈}{0, 1}, stable ^{ν̅}^{∈}{1, 0}, or a metastable state (X). In this case, metastability means a value with an unknown stability, i.e., from time to time zero or one value appears on the output Q with different non-zero probability. The second case is more complicated as it is based on SR-latch phenomenon which causes a high frequency oscillation in addition to the three values {v, X, v̅} in the first case. When both inputs S and R are fed with ‘1’ value (forbidden state) for a short period of time and at this moment EN signal changes from ‘1’ to ‘0’, the SR-latch is trying to store a forbidden state and thereby generates a damped high frequency oscillation. The metastable oscillation also transitions to the stable zero or the stable one value after some time. Accordingly, values y1 (time period from t2 to t3) and y2 (time period after t4) will eventually become a stable zero or a stable one value with or without metastable oscillation. This phenomenon is based on the unique voltage and timing characteristics of an SR-latch and can be determined only after manufacturing.

Two scenarios for generating metastable values are shown in FIG. 10B and FIG. 10C. Possible values in the first case are shown in FIG. 10B and in second case (see FIG. 10C). In FIG. 10B, for the first case, the output value y0 initially transitions to the stable values v or ν̅, or may transition to the metastable state X before then transitioning to the stable values value v or ν̅. In FIG. 10C, for the second case, the output values y1, y2 initially transition to the stable values v and ν̅, or to the metastable state X, or to a high frequency oscillation mode. The high frequency oscillation mode then transitions to the metastable state X. All the states finally transition to stable values value v or ν̅. Accordingly, while oscillation in second case is eventually damped to the value v or ν̅, the final value Q is more uncertain as compared to the first case. As a result, transition of EN signal from ‘1’ (Ring Oscillator mode) to ‘0’ (Latch mode) may cause high frequency oscillation which leads to the metastability state observed on the output Q. As a result, the metastability can be used to generate true random numbers.

### Latch

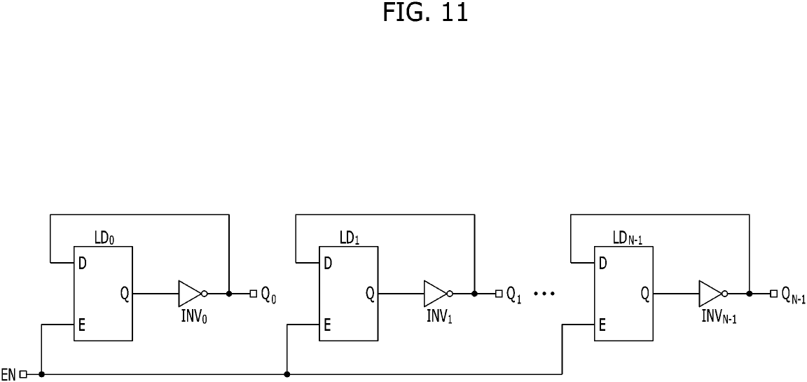

FIG. 11 is a depiction of a multi-bit latch for storing a unique ID or a random value. When the EN signal is set to a ‘0’ value, it allows for the possibility of storing random values generated after initialization or after a ring oscillation or a metastability caused oscillation. Shown in FIG. 11 is a circuit for storing N-bit unique ID (mode 1) or random number (modes 2 or 3).

In one embodiment of the present invention, the PUF circuit shown in FIG. 11 provides for an entropy source which can be used for producing unique bits or for storing generated data.

### Working Operational Examples

The entropy source of FIG. 11 has been implemented in Xilinx Artix-7 field programmable gate array (FPGA) and characteristics for each mode have been collected.

### Initial Memory

A total number of 128 entropy sources has been synthesized and implemented in the FPGA. FIG. 12 is a graph showing probabilities of ‘0’ and ‘1’ values in the initialization mode. During an E =100 test (where each PUF circuit acting as an entropy source was tested 100 times), each of the entropy source elements generated the values shown in FIG. 12 for the probability of the resultant output being ‘1’.

As shown in FIG. 12, the distribution of probabilities of generating ‘1’ value

$$\left({P}_{i}^{1} \left(E\right)\right)$$

is the following - 61 elements with

$${P}_{i}^{1} \left(E\right) =$$

0.0, 56 elements with

$${P}_{i}^{1} \left(E\right) = 1.0 ,$$

11 elements with

$$0 < {P}_{i}^{1} \left(E\right) < 1.$$

Thus, a reliable, unique and reproducible ID can be generated using the inventive PUF circuit as an entropy source, with the distribution probability representing a unique ID for the collection of 128 PUF circuits implemented in a single FPGA chip. In one embodiment, all the circuitry would be located in the single FPGA chip.

### Ring Oscillator

FIG. 13 is a graph depicting the observed frequencies in a ring oscillator RO mode of the 128 generators noted above and tested in the ring oscillator mode and shown to demonstrate the uniqueness of generated frequency value F_{Q}. The simulation (or target) frequency is 350 MHz (the horizontal line in FIG. 10 at the 350 MHz y-axis value), and the individual estimated frequency values (Fᵢ) for the 128 PUF circuits acting as entropy sources are shown in FIG. 13. FIG. 13 demonstrates that the frequency value F_{Q} for each of the 128 PUF circuits acting in the RO mode is unique and unpredictable for each entropy source.

### Metastability

The same 128 entropy sources have been tested E = 100 times in the metastability mode (EN switches from ‘1’ to ‘0’ after k=32 periods of system clock). The probabilities

$${P}_{i}^{1} \left(E , k\right)$$

of generating ‘1’ value after k system clocks in RO mode (EN=‘1’) for each element are shown in FIG. 14.

In contrast to initialization mode, the generated values for the metastability mode have low reproducibility as all probabilities of generating ‘1’ value

$$\left({P}_{i}^{1} \left(E , k\right)\right)$$

are above 0.2 and below 0.8. Thus, this mode is more suitable for generating true random values. For instance, with the output probability being both non-zero and non-one, then the output will be unpredictable. The unpredictability (irreproducibility) is one important characteristic for generating true random values.

### Latch

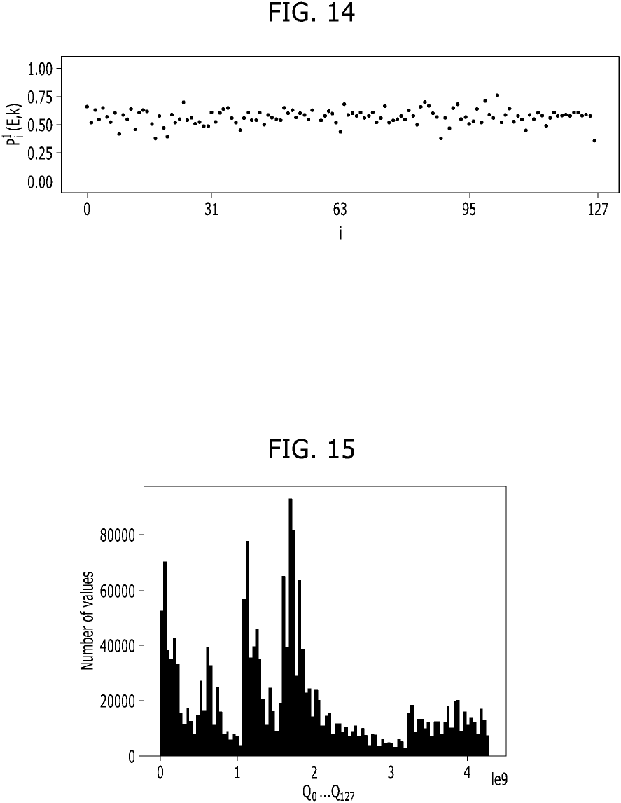

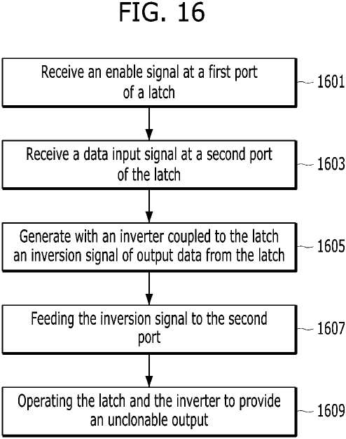

To estimate quality of random values produced by the PUF circuits acting as entropy sources, 128 elements have been utilized. As a result, a million 128-bit values have been generated by changing EN signal from ‘1’ to ‘0’. The duration of EN signal in ‘1’ state is k=32 periods of system clock. The distribution of generated 128-bit values is shown in FIG. 15. The generated values are truly random but not uniformly distributed. Therefore, the random sequence can be post-processed (or otherwise conditioned) in order to achieve a target randomness.

FIG. 16 is a diagram illustrating a method for providing an unclonable output from a circuit in accordance with another embodiment of the present invention. As depicted in FIG. 16, the method at 1601 receives an enable signal at a first port of a latch. At 1603, the method receives a data input signal at a second port of the latch. At 1605, the method generates via an inverter coupled to the latch circuit an inversion of the signal of output data from the latch. At 1607, the method feeds the inversion of the signal to the second port. At 1609, the method operates the latch circuit and the inverter to provide an unclonable output.

In this method, the latch and inverter may operate as a memory when the enable signal has a first level, may operate as a ring oscillator when the enable signal has a second level, and may have a metastable state when the enable signal changes from the second level to the first level. The operating the latch and the inverter as the ring oscillator or in the metastable state provides a random number output. The random number output comprises a physically unclonable random number. The operating the latch and the inverter as the memory at the initialization of the circuit provides at the initialization an identification pattern serving as a device identifier of the circuit.

In this method, the latch and inverter may be a plurality of latches and inverters, and the method may provide for the unclonable output a set of probabilities related to a likelihood of an individual latch-inverter combination of the plurality of latches and inverters storing a value ‘0’ or ‘1’ at initialization of the circuit.

In this method, the latch and inverter may be a plurality of latches and inverters, and the method may provide for the unclonable output a set of frequencies for individual latch-inverter combinations of the plurality of latches and inverters when the plurality of latches and inverters are operating as ring oscillators.

In this method, the latch and inverter may be a plurality of latches and inverters, and the method may provide for the unclonable output a set of frequencies for individual latch-inverter combinations of the plurality of latches and inverters when the plurality of latches and inverters are operating in metastable states.

In one embodiment of the present invention, as shown in the figures above, there is provided a latching circuit. The latching circuit has a latch including a first input port, a second input port, and an output port. The latch is configured to receive an enable signal at the first input port. The latching circuit has an inverter coupled to the latch, configured to generate an inverted signal of data output from the latch, and configured to provide the inverted signal back to the second input port. The latch and the inverter operate as a memory when the enable signal has a first level, operate as a ring oscillator when the enable signal has a second level, and have a metastable state when the enable signal changes from the second level to the first level.

In one embodiment, the latching circuit also includes a controller configured to provide the enable signal to the latch.

In one embodiment, the controller is configured to provide the enable signal at one of the first level and the second level. In another embodiment, the controller is configured to change the enable signal from the first level to the second level, and the controller is configured to change the enable signal from the second level to the first level.

In one embodiment, the latch (operating as the ring oscillator) outputs a random number, for the randomized data, that is physically unclonable. Alternatively, the latch (operating in the metastable state) outputs a random number, for the randomized data, that is physically unclonable. Alternatively, the latch (operating as the memory device at initialization of the circuit) outputs an identification pattern serving as a device identifier of the circuit.

In one embodiment, the latch comprises a set-reset latch having a first NOR gate, a second NOR gate, a set input for the first NOR gate, a reset input for the second NOR gate, a first data output of the first NOR gate coupled to the second NOR gate, and a second data output of the second NOR gate provided to the inverter. The latch may further comprise: a first AND gate coupled to the set input of the first NOR gate, and a second AND gate coupled to the reset input of the second NOR gate. In this embodiment, the inverter is configured to receive the second data output of the second NOR gate between, invert the second data output, and provide the inverted second data output to both the first and second NAND gates.

In another embodiment of the invention, there is provided a memory system comprising a semiconductor memory device having a control circuit and a latching circuit. The latching circuit comprises a latch including a first input port, a second input port, and an output port, the latch configured to receive an enable signal at the first input port. The latching circuit also comprises an inverter coupled to the latch, configured to generate an inverted signal of data output from the latch, and configured to provide the inverted signal back to the second input port. In this embodiment, the controller is configured to operate the latching circuit as either a ring oscillator for random number generation or a memory for data storage.

In this memory system, the latching circuit comprises a set-reset latch having a first NOR gate, a second NOR gate, a set input for the first NOR gate, a reset input for the second NOR gate, a first data output of the first NOR gate coupled to the second NOR gate, and a second data output of the second NOR gate provided to the inverter. In this memory system, the latching circuit also comprises a first AND gate coupled to the set input of the first NOR gate, and a second AND gate coupled to the reset input of the second NOR gate.

Although the foregoing embodiments have been illustrated and described in some detail for purposes of clarity and understanding, the present invention is not limited to the details provided. There are many alternative ways of implementing the invention, as one skilled in the art will appreciate in light of the foregoing disclosure. The disclosed embodiments are thus illustrative, not restrictive. The present invention is intended to embrace all modifications and alternatives of the disclosed embodiment. Furthermore, the disclosed embodiments may be combined to form additional embodiments.

Indeed, implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be excised from the combination, and the combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A latching circuit comprising:
a latch including a first input port, a second input port, and an output port, the latch configured to receive an enable signal at the first input port; and
an inverter coupled to the latch, configured to generate an inverted signal of data output from the latch, and configured to provide the inverted signal back to the second input port,
wherein the latch and the inverter operate as a memory when the enable signal has a first level, operate as a ring oscillator when the enable signal has a second level, and have a metastable state when the enable signal changes from the second level to the first level.

2. The circuit of claim 1, further comprising a controller configured to provide the enable signal to the latch.

3. The circuit of claim 2, wherein the controller is configured to provide the enable signal at one of the first level and the second level.

4. The circuit of claim 2, wherein
the controller is configured to change the enable signal from the first level to the second level, and
the controller is configured to change the enable signal from the second level to the first level.

5. The circuit of claim 1, wherein the latch operating as the ring oscillator outputs a random number, for the randomized data, that is physically unclonable.

6. The circuit of claim 1, wherein the latch operating in the metastable state outputs a random number, for the randomized data, that is physically unclonable.

7. The circuit of claim 1, wherein the latch operating as the memory device at initialization of the circuit outputs an identification pattern serving as a device identifier of the circuit.

8. The circuit of claim 1, wherein the latch comprises a set-reset latch having a first NOR gate, a second NOR gate, a set input for the first NOR gate, a reset input for the second NOR gate, a first data output of the first NOR gate coupled to the second NOR gate, and a second data output of the second NOR gate provided to the inverter.

9. The circuit of claim 8, wherein the latch further comprises:
a first AND gate coupled to the set input of the first NOR gate, and
a second AND gate coupled to the reset input of the second NOR gate.

10. The circuit of claim 9, wherein the inverter is configured to receive the second data output of the second NOR gate between, invert the second data output, and provide the inverted second data output to both the first and second NAND gates.

11. A method for providing an unclonable output from a circuit, comprising:
receiving an enable signal at a first port of a latch;
receiving a data input signal at a second port of the latch;
generating via an inverter coupled to the latch an inversion of the signal of output data from the latch;
feeding the inversion of the signal to the second port; and
operating the latch and the inverter to provide the unclonable output.

12. The method of claim 11, wherein the latch and inverter operate as a memory when the enable signal has a first level, operate as a ring oscillator when the enable signal has a second level, and have a metastable state when the enable signal changes from the second level to the first level.

13. The method of claim 12, wherein the operating the latch and the inverter as the ring oscillator or in the metastable state provides a random number output.

14. The method of claim 13, wherein the random number output comprises a physically unclonable random number.

15. The method of claim 12, wherein the operating the latch and the inverter as the memory at the initialization of the circuit provides at the initialization an identification pattern serving as a device identifier of the circuit.

16. The method of claim 11, wherein the latch and the inverter comprise a plurality of latches and inverters, and the method further comprises providing for the unclonable output a set of probabilities related to a likelihood of an individual latch-inverter combination of the plurality of latches and inverters storing a value ‘0’ or ‘1’ at initialization of the circuit.

17. The method of claim 11, wherein the latch and the inverter comprise a plurality of latches and inverters, and the method further comprises providing for the unclonable output a set of frequencies for individual latch-inverter combinations of the plurality of latches and inverters when the plurality of latches and inverters are operating as ring oscillators.

18. The method of claim 11, wherein the latch and the inverter comprise a plurality of latches and inverters, and the method further comprises providing for the unclonable output a set of frequencies for individual latch-inverter combinations of the plurality of latches and inverters when the plurality of latches and inverters are operating in metastable states.

19. A memory system comprising:
a semiconductor memory device having a control circuit and a latching circuit,
wherein the latching circuit comprises
a latch including a first input port, a second input port, and an output port, the latch configured to receive an enable signal at the first input port; and
an inverter coupled to the latch, configured to generate an inverted signal of data output from the latch, and configured to provide the inverted signal back to the second input port;
wherein the controller is configured to operate the latching circuit as either a ring oscillator for random number generation or a memory for data storage.

20. The memory system of claim 19, wherein the latching circuit comprises:
a set-reset latch having a first NOR gate, a second NOR gate, a set input for the first NOR gate, a reset input for the second NOR gate, a first data output of the first NOR gate coupled to the second NOR gate, and a second data output of the second NOR gate provided to the inverter,
a first AND gate coupled to the set input of the first NOR gate, and
a second AND gate coupled to the reset input of the second NOR gate.
